(19) United States
(12) Patent Application Publication
(10) Pub. No.: US 2021/0207567 A1
(43) Pub. Date: Jul. 8, 2021

(54) FUEL SUPPLY PUMP

(71) Applicant: HITACHI AUTOMOTIVE SYSTEMS, LTD., Hitachinaka-shi, Ibaraki (JP)

(72) Inventors: Shingo TAMURA, Hitachinaka-shi (JP); Kenichiro TOKUO, Hitachinaka-shi (JP); Masayuki SUGANAMI, Hitachinaka-shi (JP); Kazuaki TOKUMARU, Hitachinaka-shi (JP)

(73) Assignee: HITACHI AUTOMOTIVE SYSTEMS, LTD., Hitachinaka-shi, Ibaraki (JP)

(21) Appl. No.: 16/762,792

(22) PCT Filed: Dec. 7, 2018
(86) PCT No.: PCT/JP2018/045020

§ 371 Date: May 8, 2020

(30) Foreign Application Priority Data
Dec. 26, 2017 (JP) 2017-248640

(51) Int. Cl. F02M 59/44; F04B 53/14; F02M 59/02

(52) U.S. Cl. CPC F02M 59/44; F02M 59/025; F04B 53/14

(57) ABSTRACT

An object of the invention is to provide a fuel supply pump that improves the lubricity of a plunger that reciprocates on the inner circumference of a cylinder in order to suppress sticking of the plunger that may occur with increasing pressure of fuel. A fuel supply pump includes a plunger that reciprocates in an inner peripheral portion of a cylinder, and a pressurizing chamber that is pressurized by the plunger. An annular groove is formed on an outer periphery of the plunger. The annular groove is located closer to the pressurizing chamber than an axial center position of a cylinder sliding region at the bottom dead center position.

### TECHNICAL FIELD

The present invention relates to a fuel supply pump.

### BACKGROUND ART

In an internal combustion engine of a direct injection type in which fuel is directly injected into a combustion chamber of the internal combustion engine, a high-pressure fuel pump is widely used to increase the pressure of the fuel. As a related art of the high-pressure fuel pump, there is a high-pressure fuel pump disclosed in JP 2017-25924 A. PTL 1 describes that “the cylinder 6 holds the plunger 2 which moves forward and backward in a pressurizing chamber 11 so as to be slidable along the direction of the forward and backward movement.”

### CITATION LIST

### Patent Literature

PTL 1: JP 2017-25924 A

### SUMMARY OF INVENTION

### Technical Problem

In recent years, high-pressure fuel pumps have been required to supply high-pressure fuel, for example, by setting the discharge pressure to 20 MPa or more. For this purpose, it is necessary to increase the fuel pressure in the pressurizing chamber. However, the inventor of the invention has found that the plunger and the cylinder may stick together with the increase in the fuel pressure.

An object of the invention is to provide a fuel supply pump that improves the lubricity of a plunger that reciprocates on the inner circumference of a cylinder in order to suppress sticking of the plunger that may occur with increasing pressure of fuel.

### Solution to Problem

In order to achieve the above object, according to the invention, there is provided a fuel supply pump which includes a plunger that reciprocates in an inner peripheral portion of a cylinder, and a pressurizing chamber that is pressurized by the plunger. An annular groove is formed on an outer periphery of the plunger. The annular groove is located closer to the pressurizing chamber than an axial center position of a cylinder sliding region at the bottom dead center position.

### Advantageous Effects of Invention

According to this invention, a fuel supply pump which improves a lubricity of a plunger which reciprocates in a cylinder inner periphery can be provided. Objects, configurations, and effects besides the above description will be apparent through the explanation on the following embodiments.

### BRIEF DESCRIPTION OF DRAWINGS

FIG. 1 is a vertical cross-sectional view of a fuel supply pump according to an embodiment when viewed from a lateral direction.

FIG. 2 is a horizontal cross-sectional view of the fuel supply pump of this embodiment when viewed from above.

FIG. 3 is a vertical cross-sectional view of the fuel supply pump of this embodiment viewed from a lateral direction different from FIG. 1.

FIG. 4 is an enlarged cross-sectional view of an electromagnetic suction valve mechanism mounted on the fuel supply pump of this embodiment.

FIG. 5 is a configuration diagram of a fuel supply system including a fuel supply pump of this embodiment.

FIG. 6 is a cross-sectional view illustrating a plunger 2 taken along the axial direction in the fuel supply pump of this embodiment.

FIG. 7 illustrates a state where the position of the plunger 2 of this embodiment is at a top dead center and at a bottom dead center.

FIG. 8 is an enlarged view of the plunger 2 of this embodiment, illustrating the details of an annular groove 2c.

### DESCRIPTION OF EMBODIMENTS

Hereinafter, embodiments of the invention will be described using the drawings. In the following description, the vertical direction in the drawings may be specified and described, but this vertical direction does not mean the vertical direction when a fuel supply pump is mounted.

### First Embodiment

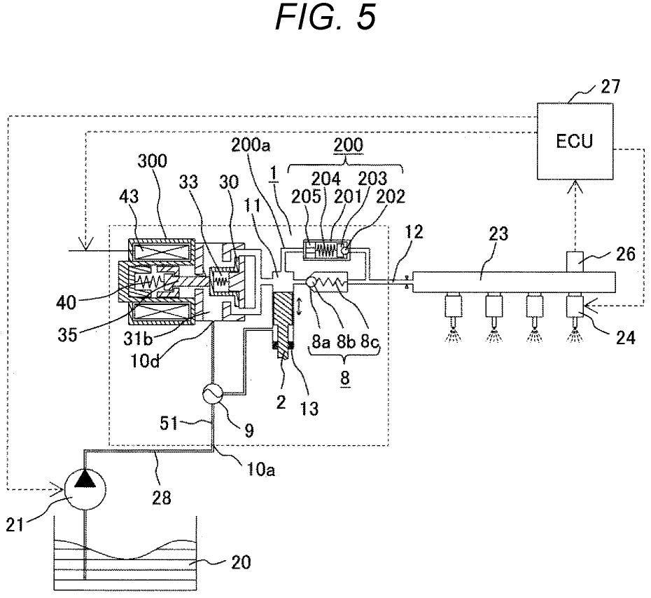

FIG. 5 is a configuration diagram illustrating an example of a fuel supply system including a fuel supply pump. A portion surrounded by a broken line indicates a pump body 1 of the fuel supply pump, and the mechanisms/components illustrated in the broken line are integrally assembled in the pump body 1 of the fuel supply pump.

The fuel of a fuel tank 20 is pumped up by a feed pump 21 on the basis of a signal from an engine control unit (ECU) 21. The fuel is pressurized to an appropriate feed pressure to be passed through a suction pipe 28, and sent to a low-pressure fuel suction port 10a of the fuel supply pump. The fuel passing from the low-pressure fuel suction port 10a through a suction joint 51 reaches a suction port 31b of an electromagnetic suction valve mechanism 300 of a capacity variation mechanism through a pressure pulsation damping mechanism 9 and a suction passage 10d.

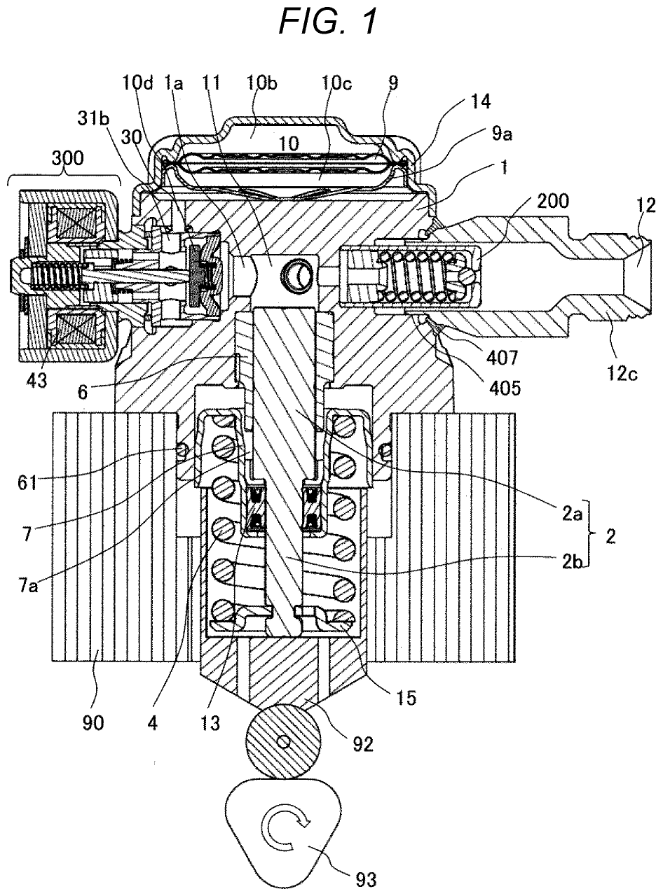

The fuel flowing to the electromagnetic suction valve mechanism 300 passes through a suction valve 30 and flows into a pressurizing chamber 11. A plunger 2 is applied with power of a reciprocating motion by a cam mechanism 93 (see FIG. 1) of an engine. In a downward stroke of the plunger 2, the fuel is sucked from the suction valve 30 by the reciprocating motion of the plunger 2. The fuel is pressurized in an upward stroke. The pressurized fuel is sent through a discharge valve mechanism 8 to a common rail 23 on which a pressure sensor 26 is mounted.

On the common rail 23, an injector 24 (so-called direct injector) for directly injecting fuel into a cylinder of an engine (not illustrated) and a pressure sensor 26 are mounted. The direct injectors 24 are mounted in accordance with the number of cylinders (cylinders) of the engine, open and close according to control signals from the ECU 27, and inject fuel into the cylinders. The fuel supply pump (fuel supply pump) of this embodiment is applied to a so-called direct injection engine system in which the injector 24 directly injects fuel into a cylinder of the engine.

When an abnormally high pressure is generated in the common rail 23 due to a failure of the direct injector 24 or the like, and the differential pressure between the pressure of a fuel discharge port 12 of the fuel supply pump and the pressure of the pressurizing chamber 11 is equal to or more than the valve opening pressure of a relief valve mechanism 200, a relief valve 202 opens. In this case, the abnormally high pressure fuel of the common rail 23 passes through the inside of the relief valve mechanism 200, and is returned from a relief passage 200a to the pressurizing chamber 11. This makes it possible to protect the common rail 23 (high-pressure pipe). The invention can be similarly applied to a system in which the relief passage 200a is connected to a low-pressure fuel chamber (see FIG. 1), and the abnormally high-pressure fuel is returned to the low-pressure passage.

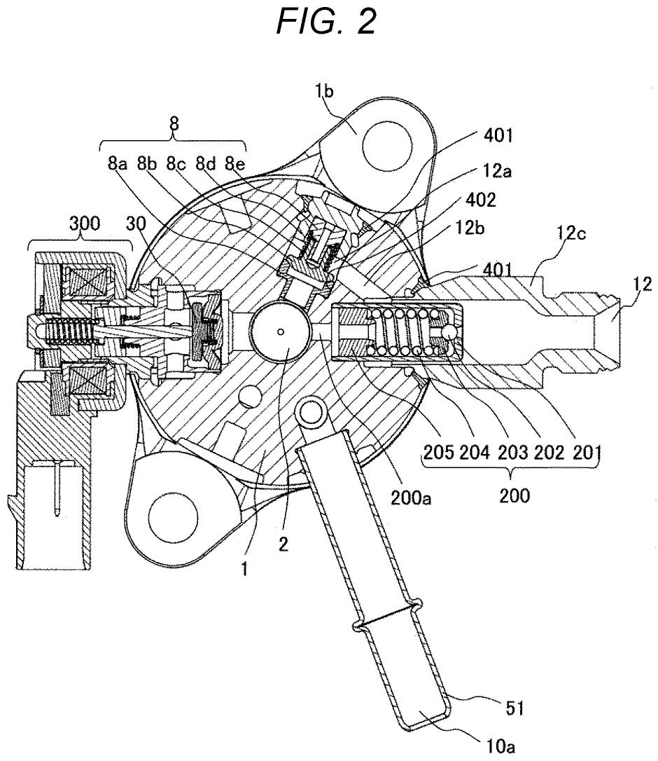

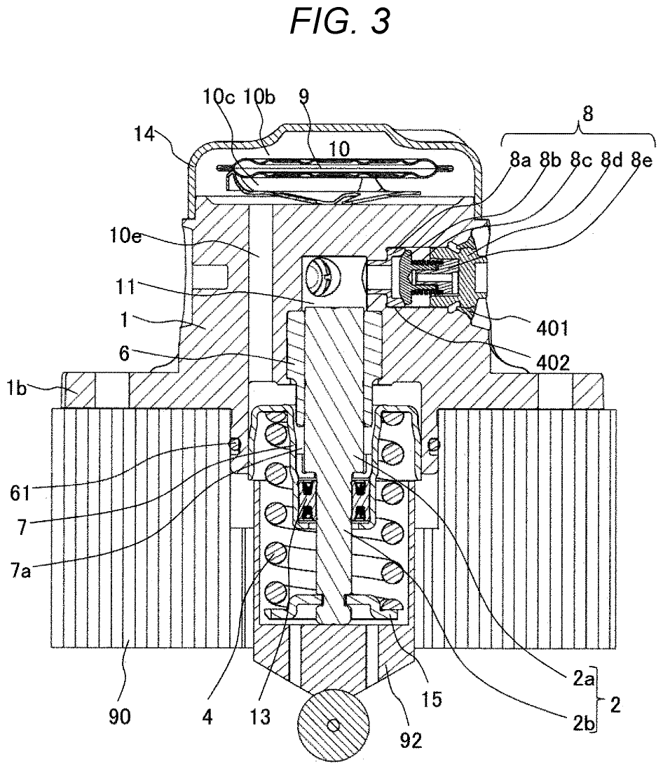

The fuel supply pump of this embodiment will be described with reference to FIGS. 1, 2 and 3. FIG. 1 is a cross-sectional view illustrating a cross section of the fuel supply pump of this embodiment, which is parallel to the center axial direction of the plunger. FIG. 2 is a horizontal cross-sectional view when viewed from above the fuel supply pump of this embodiment. FIG. 3 is a cross-sectional view of the fuel supply pump of this embodiment viewed from a direction different from FIG. 1.

Although the suction joint 51 is provided on the side surface of the body in FIG. 2, the invention is not limited to this, and is also applicable to a fuel supply pump in which the suction joint 51 is provided on the upper surface of a damper cover 14. The suction joint 51 is connected to a low-pressure pipe for supplying fuel from the fuel tank 20 of the vehicle, and the fuel flowing from the low-pressure fuel suction port 10a of the suction joint 51 flows through a low-pressure passage formed inside the pump body 1. At the inlet of the fuel passage formed in the pump body 1, a suction filter (not illustrated) press-fitted into the pump body 1 is provided, and the suction filter prevents foreign substances present between the fuel tank 20 and the low-pressure fuel suction port 10a from flowing into the fuel supply pump.

The fuel flows upward from the suction joint 51 in the axial direction of the plunger, and flows into the low-pressure fuel chamber 10 formed by an upper damper portion 10b and a lower damper portion 10c illustrated in FIG. 1. The low-pressure fuel chamber 10 is formed by being covered by a damper cover 14 attached to the pump body 1. The fuel whose pressure pulsation has been reduced by the pressure pulsation damping mechanism 9 in the low-pressure fuel chamber 10 reaches the suction port 31b of the electromagnetic suction valve mechanism 300 via the low-pressure fuel passage 10d. The electromagnetic suction valve mechanism 300 is attached to a lateral hole formed in the pump body 1 and supplies a desired flow rate of fuel to the pressurizing chamber 11 through a pressurizing chamber inlet flow path 1a formed in the pump body 1. An O-ring 61 is fitted to the pump body 1 to seal between the cylinder head 90 and the pump body 1, and prevents engine oil from leaking out.

As illustrated in FIG. 1, a cylinder 6 for guiding the reciprocating movement of the plunger 2 is attached to the pump body 1. The cylinder 6 is fixed to the pump body 1 on the outer peripheral side by press fitting and swaging. The surface of the cylindrical press-fitting portion of the cylinder 6 seals so as not to leak the pressurized fuel from the gap between the cylinder 6 and the pump body 1 to the low-pressure side. The upper end surface of the cylinder 6 is brought into contact with the plane of the pump body 1 in the axial direction to form a double sealing structure in addition to the sealing of the cylindrical press-fitting portion between the pump body 1 and the cylinder 6.

In the lower end of the plunger 2, there is provided a tappet 92 which converts a rotation motion of the cam 93 mounted in a cam shaft of the internal combustion engine into an up-down motion, and transmits the up-down motion to the plunger 2. The plunger 2 is tightly pressed to the tappet 92 by a spring 4 through a retainer 15. With this configuration, the plunger 2 can make a reciprocating motion in the vertical direction according to the rotation motion of the cam 93.

In addition, a plunger seal 13 held in the lower end portion of the inner periphery of a seal holder 7 is placed to come into slidable contact with the outer periphery of the plunger 2 in the lower portion in the drawing of the cylinder 6. With this configuration, when the plunger 2 slides, the fuel in an auxiliary chamber 7a is sealed, and prevented from flowing into the internal combustion engine. At the same time, the plunger seal 13 prevents lubricating oil (also including the engine oil) for lubricating the sliding portion in the internal combustion engine from flowing into the pump body 1.

As illustrated in FIG. 2, the pump body 1 is formed with a lateral hole for mounting the electromagnetic suction valve mechanism 300, a lateral hole for mounting the discharge valve mechanism 8 at the same position in the plunger axial direction, a lateral hole for further mounting the relief valve mechanism 200, and a lateral hole for mounting a discharge joint 12c. The fuel pressurized in the pressurizing chamber 11 via the electromagnetic suction valve mechanism 300 flows through a discharge passage 12b via the discharge valve mechanism 8, and is discharged from the fuel discharge port 12 of the discharge joint 12c.

The discharge valve mechanism 8 (FIGS. 2 and 3) provided in the outlet side of the pressurizing chamber 11 is configured by a discharge valve seat 8a, a discharge valve 8b which comes into contact with or separates from the discharge valve seat 8a, a discharge valve spring 8c which biases the discharge valve 8b toward the discharge valve seat 8a, a discharge valve plug 8d, and a discharge valve stopper 8e which determines a stroke (moving distance) of the discharge valve 8b. The discharge valve plug 8d and the pump body 1 are joined by a welding portion 401, and this joining portion shuts off the inside space through which fuel flows and the outside. The discharge valve seat 8a is joined to the pump body 1 by a press-fitting portion 402.

In a state where there is no differential pressure between the fuel pressure of the pressurizing chamber 11 and the fuel pressure of a discharge valve chamber 12a, the discharge valve 8b is tightly pressed to the discharge valve seat 8a by the urging force of the discharge valve spring 8c, and enters a closed state.

Only when the fuel pressure of the pressurizing chamber 11 becomes larger than that of the discharge valve chamber 12a, the discharge valve 8b is opened against the discharge valve spring 8c. Then, a high-pressure fuel in the pressurizing chamber 11 is discharged to the common rail 23 through the discharge valve chamber 12a, the fuel discharge passage 12b, and the fuel discharge port 12.

When being opened, the discharge valve 8b comes into contact with the discharge valve stopper 8e, and the stroke is restricted. Therefore, the stroke of the discharge valve 8b is appropriately determined by the discharge valve stopper 8e. With this configuration, it is possible to prevent the fuel discharged at a high pressure to the discharge valve chamber 12a from flowing back into the pressurizing chamber 11 because of delay in the close of the discharge valve 8b due to excessively large stroke. Therefore, deterioration in efficiency of the fuel supply pump can be suppressed. In addition, when the discharge valve 8b repeatedly opens and closes, the discharge valve 8b is guided by the outer peripheral surface of the discharge valve stopper 8e such that the discharge valve 8b moves only in the stroke direction.

As described above, the pressurizing chamber 11 is configured by the pump body 1, the electromagnetic suction valve mechanism 300, the plunger 2, the cylinder 6, and the discharge valve mechanism 8. As illustrated in FIGS. 2 and 3, the fuel supply pump according to this embodiment uses a mounting flange 1b provided on the pump body 1 to closely adhere to the plane of the cylinder head 90 of the internal combustion engine, and is fixed by a plurality of bolts (not illustrated).

The relief valve mechanism 200 includes a seat member 201, the relief valve 202, a relief valve holder 203, a relief spring 204, and a holder member 205. The relief valve mechanism 200 is a valve that is configured to operate when an abnormally high pressure occurs due to some problem in the common rail 23 or a member near before. When the pressure in the common rail 23 or the member near before becomes high, the valve is opened to return the fuel to the pressurizing chamber 11 or the low-pressure passage (the low-pressure fuel chamber 10 or the suction passage 10d). Therefore, it is necessary to maintain the valve-closed state below a predetermined pressure, and has the very strong spring 204 to oppose high pressure.

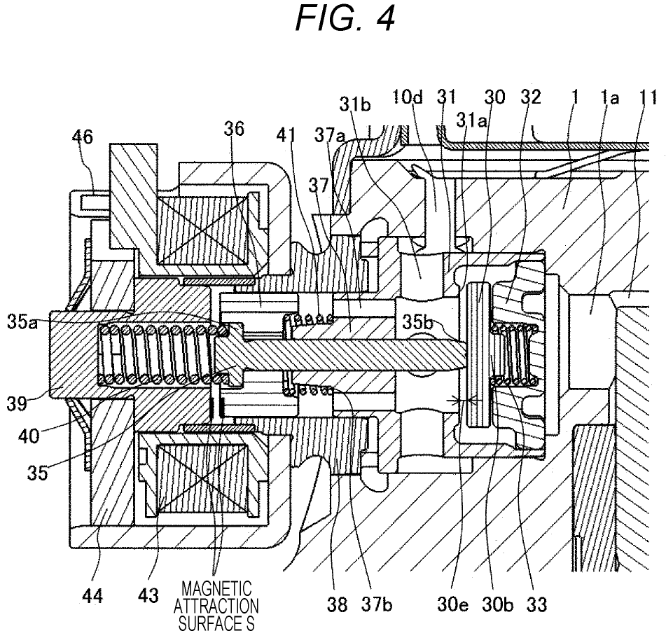

The electromagnetic suction valve mechanism 300 will be described with reference to FIG. 4. FIG. 4 is an enlarged cross-sectional view of the electromagnetic suction valve mechanism of this embodiment, illustrating a cross section parallel to the driving direction of the suction valve, and a cross-sectional view illustrating a state where the suction valve is opened.

In the non-energized state, the suction valve 30 is operated in the valve open direction by a strong rod urging spring 40, so that it is a normally open type. If a control signal from the ECU 27 is applied to the electromagnetic suction valve mechanism 300, the current flows to an electromagnetic coil 43 through a terminal 46. When a current flows through the electromagnetic coil 43, a movable core 36 is attracted in the valve closing direction on a magnetic attraction surface S by the magnetic attraction force of a magnetic core 39. The rod urging spring 40 is disposed in a concave portion formed in the magnetic core 39 and urges a flange portion 35a. The flange portion 35a is engaged with the concave portion of the movable core 36 on the side opposite to the rod urging spring 40.

The magnetic core 39 is configured to be in contact with a lid member 44 that covers the electromagnetic coil chamber in which the electromagnetic coil 43 is disposed. When the movable core 36 is attracted and moved by the magnetic core 39, the movable core 36 is engaged with the flange portion 35a of a rod 35, and the rod 35 moves together with the movable core 36 in the valve closing direction. Between the movable core 36 and the suction valve 30, a valve closing urging spring 41 for urging the movable core 36 in the valve closing direction, and a rod guide member 37 for guiding the rod 35 in the opening and closing valve direction are arranged. The rod guide member 37 forms a spring seat 37b of the valve closing urging spring 41. Further, the rod guide member 37 is provided with a fuel passage 37a, which allows the fuel to flow into and out of the space in which the movable core 36 is disposed.

The movable core 36, the valve closing urging spring 41, the rod 35 and the like are contained in an electromagnetic suction valve mechanism housing 38 fixed to the pump body 1. Further, the magnetic core 39, the rod urging spring 40, the electromagnetic coil 43, the rod guide member 37, and the like are held in the electromagnetic suction valve mechanism housing 38. The rod guide member 37 is mounted to the electromagnetic suction valve mechanism housing 38 on the side opposite to the magnetic core 39 and the electromagnetic coil 43, and includes the suction valve 30, a suction valve urging spring 33, and a stopper 32.

The suction valve 30, the suction valve urging spring 33, and the stopper 32 are provided on a side of the rod 35 opposite to the magnetic core 39. The suction valve 30 is formed with a guide portion 30b projecting toward the pressurizing chamber 11 and guided by the suction valve urging spring 33. The suction valve 30 moves in the valve open direction (the direction away from a valve seat 31a) by the gap of a valve body stroke 30e with the movement of the rod 35, and becomes a valve open state. The fuel is supplied from a supply passage 10d to the pressurizing chamber 11. The guide portion 30b stops moving by colliding with the stopper 32 fixed by being pressed into the housing (the rod guide member 37) of the electromagnetic suction valve mechanism 300. The rod 35 and the suction valve 30 are separate and independent structures. The suction valve 30 closes the flow path to the pressurizing chamber 11 by contacting the valve seat 31a of a valve seat member 31 disposed on the suction side, and opens the flow path to the pressurizing chamber 11 by separating from the valve seat 31a.

When the plunger 2 moves in the direction (lower direction) of the cam 93 and enters a suction stroke state while the cam 93 of FIG. 1 rotates, the volume of the pressurizing chamber 11 is increased and the fuel pressure in the pressurizing chamber 11 is lowered. When the electromagnetic coil 43 is de-energized during this suction stroke, the sum of the urging force of the rod urging spring 40 and the fluid force due to the pressure in the suction passage 10d becomes larger than the fluid force due to the fuel pressure in the pressurizing chamber 11. Thus, the suction valve 30 is urged by the rod 35 in the valve open direction to be in the valve open state.

When the plunger 2 reaches the bottom dead center and completes the suction stroke, the plunger 2 starts to move upward. Herein, the electromagnetic coil 43 keeps a non-energization state, and a magnetic urging force does not operate. The volume of the pressurizing chamber 11 is reduced according to the compression movement of the plunger 2. However, in this state, the fuel once sucked into the pressurizing chamber 11 returns to the suction passage 10d through the opening of the suction valve 30 which enters the valve open state again. Therefore, the pressure of the pressurizing chamber 11 is not increased. This stroke is called a returning stroke.

Thereafter, by turning on the energization of the electromagnetic coil 43 at a desired timing, the magnetic attraction force is generated as described above, so that the rod 35 moves in the valve closing direction together with the movable core 36, and a tip portion 35b of the rod 35 is separated from the suction valve 30. In this state, the suction valve 30 is a check valve that opens and closes according to the differential pressure, and is closed by the urging force of the suction valve urging spring 33. After the suction valve 30 is closed, the plunger 2 is raised, so that the volume of the pressurizing chamber 11 is reduced, and the fuel is pressurized. This is called a compression stroke. When the fuel in the pressurizing chamber 11 is pressurized and the pressure of the fuel exceeds the sum of the fuel pressure in the discharge valve chamber 12a and the urging force of the discharge valve spring 8c, the discharge valve 8b opens to discharge the fuel.

The amount of the discharging high-pressure fuel can be controlled by controlling timing for energizing the electromagnetic coil 43 of the electromagnetic suction valve mechanism 300. If the timing for energizing the electromagnetic coil 43 is set to be advanced, the ratio of the returning stroke in the compression stroke becomes small, and the ratio of the discharge stroke becomes large. In other words, the fuel returning to the suction passage 10d becomes less, and the high-pressure fuel discharged to the common rail 23 becomes large. On the other hand, if the energizing timing is set to be delayed, the ratio of the returning stroke in the compression stroke becomes large, and the ratio of the discharge stroke becomes small. In other words, the fuel returning to the suction passage 10d becomes large, and the high-pressure fuel discharged to the common rail 23 becomes less. The timing for energizing the electromagnetic coil 43 is controlled by a command from the ECU 27.

As described above, it is possible to control the amount of high-pressure fuel to be discharged as much as the internal combustion engine requires by controlling the timing for energizing the electromagnetic coil 43.

In the low-pressure fuel chamber 10, the pressure pulsation damping mechanism 9 is provided to reduce the propagation of the pressure pulsation generated in the fuel supply pump to a fuel pipe 28. Above and below the pressure pulsation damping mechanism 9, an upper damper portion 10b and the lower damper portion 10c are provided at intervals. In a case where the fuel flown into the pressurizing chamber 11 returns to the suction passage 10d through the suction valve 30 which enters the valve open state again to control the volume, the pressure pulsation is generated in the low-pressure fuel chamber 10 by the fuel returned to the suction passage 10d. However, the pressure pulsation damping mechanism 9 provided in the low-pressure fuel chamber 10 is formed by metal diaphragm damper formed by bonding two disk-like metal plates of a corrugate shape at the outer periphery and with an inert gas such as argon injected therein, so that the pressure pulsation is absorbed and reduced as the metal damper expands and contracts. Reference numeral 9a denotes a mounting bracket for fixing the metal damper to the inner peripheral portion of the pump body 1, and is provided on the fuel passage. The support part with the damper is not a whole circumference but a part, so that the fluid can freely flow between the front and back of the mounting bracket 9a.

The plunger 2 includes a large diameter portion 2a and a small diameter portion 2b. The volume of the auxiliary chamber 7a is increased or decreased according to the reciprocating motion of the plunger 2. The auxiliary chamber 7a is connected to the low-pressure fuel chamber 10 by a fuel passage 10e (see FIG. 3). The fuel flows from the auxiliary chamber 7a to the low-pressure fuel chamber 10 when the plunger 2 descends. The fuel flows from the low-pressure fuel chamber 10 to the auxiliary chamber 7a when the plunger ascends.

With this configuration, the fuel flow rate to the inside and outside of the pump in the suction stroke or the returning stroke of the pump can be reduced, and the pressure pulsation generated in the fuel supply pump is reduced.

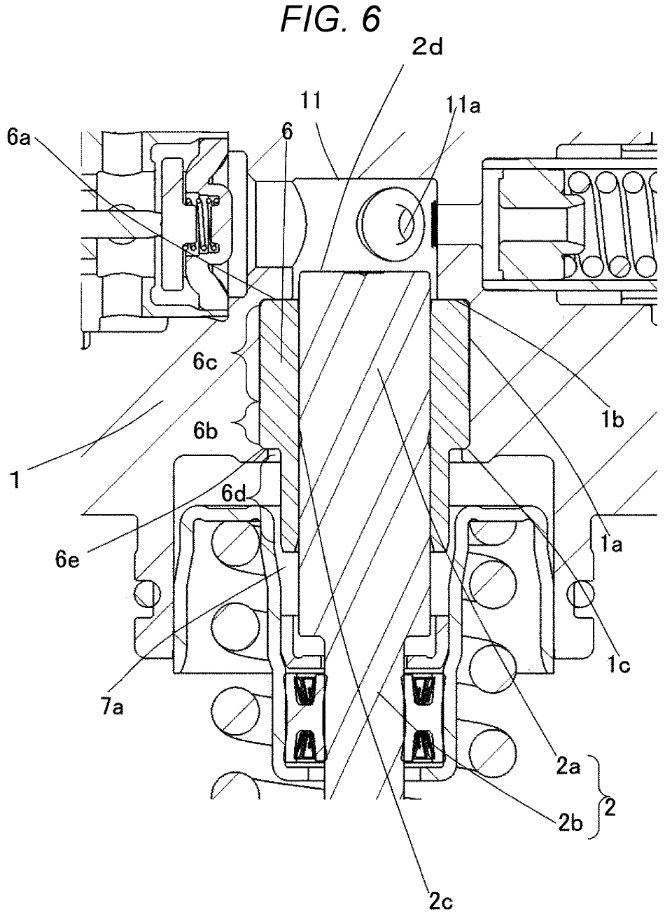

Hereinafter, the structure of the plunger 2 of this embodiment will be described in detail with reference to FIGS. 6, 7, and 8. FIG. 6 is a cross-sectional view illustrating the plunger 2 taken along the axial direction in the fuel supply pump of this embodiment. In the fuel supply pump of this embodiment, the pressurizing chamber 11a is formed by forming a hole 1a from below in a member of the pump body 1. A contact end surface 6a of the cylinder 6 comes into contact with an upper end 1b of the pump body 1 forming the hole 1a. FIG. 6 illustrates a state where the plunger 2 is at the bottom dead center. At this time, the tip portion of the plunger 2 is configured to protrude toward the pressurizing chamber 11 (the upper side of FIG. 6) from the contact end surface 6a of the cylinder 6.

The contact surface (tightly pressed portion) between the cylinder 6 and the pump body 1 and a clearance configuration will be described. As a fixing portion with respect to the pump body 1 of the cylinder 6, there is a press-fitting portion 6b which is a convex portion of the cylinder 6. Then, the pump body 1 and the press-fitting portion 6b are press-fitted into each other so as to be fixed. With this configuration, the fixing can be made by simple work. Further, a method of fixing the cylinder 2 and the pump body 1 may be fixed by a screw instead of the press-fitting portion 6b. In addition, a clearance 6c spacing from the pump body 1 is formed in a region near the pressurizing chamber side from the press-fitting portion 6b. The cylinder 6 further has a guide portion 6d below the press-fitting portion 6b (convex portion) in the axial direction. The thickness in the radial direction of the guide portion 6d is configured to be small compared to the thickness in the radial direction of the press-fitting portion 6d. In addition to the inner side surface in the radial direction of the press-fitting portion 6b and the inner side surface in the radial direction of the clearance 6c, the guide portion 6d is provided, so that the inclination of the plunger 2 can be suppressed. Therefore, it is possible to suppress the cylinder 6 from being stuck. A side force added to the plunger seal 13 and the seal holder 7 where the plunger seal 13 is assembled can be reduced.

In addition, as a fixing method of the cylinder 6, the outer diameter portion (outer peripheral portion) 6b of the cylinder 6 is press-fitted into the pump body 1, and an end surface 6e on the opposite side of the pressurizing chamber of the cylinder 6 is combined to the pump body 1 by plastic deformation of a swaged portion 1c of the pump body 1. In this case, the cylinder 6 is tightly pressed to the contact surface (the swaged portion 1c) of the pump body 1, and the pressing force is set to be added toward the upper side in the axial direction so as to fix the cylinder 6 to the pump body 1.

A gap is formed between the radially outer cylindrical portion of the plunger 2 and the inner cylindrical portion of the cylinder 6, and fuel flows into the gap to lubricate the sliding portion. Further, the pressurizing chamber 11 side is filled with high-pressure fuel from the sliding portion, and the lower end side of the cylinder 6 is an area filled with low-pressure fuel. Therefore, if the gap is large, the lubricating effect increases, but the amount of high-pressure fuel leaking through the gap to the low-pressure fuel region also increases. Therefore, since the discharge efficiency of the high-pressure fuel pump is reduced, it is desirable that the gap between the sliding portions be as small as possible.

On the other hand, when the lubrication of the fuel is lost, the fuel is easily fixed at the sliding portion between the cylinder 6 and the plunger 2. When the fuel supply pump is driven, the plunger 2 repeats a high-speed reciprocating motion, and the plunger 2 slides on the inner peripheral side of the cylinder 6. In recent years, since the discharge pressure of the fuel supply pump has been required to be high pressure such as 20 MPa or more, the inventors have found that the upper side of the sliding portion of the plunger 2 (the side of the pressurizing chamber 11) can be equal to or less than a saturated vapor pressure as a result of experiments.

That is, since the pressure in the pressurizing chamber 11 is high and the pressure in the auxiliary chamber 7a is low, the fuel flows from the pressurizing chamber 11 toward the auxiliary chamber 7a. This flow path is very narrow because it is a gap between the plunger 2 and the cylinder 7. If there is no groove, the flow path area is constant, so that the flow velocity of the flowing fuel increases as the pressure difference increases. The smaller the flow path area, the longer the flow path, and the faster the flow velocity, the more likely a negative pressure is generated. For this reason, according to the conventional structure, the upper side of the sliding portion of the plunger 2 (the pressurizing chamber 11 side) sometimes becomes equal to or less than the saturated vapor pressure of the fuel, and the inventors have found this problem.

In this case, the fuel may evaporate in the sliding portion of the plunger 2, and as a result, the sliding portion of the plunger 2 may not be lubricated. This is because the pressure in the sliding portion tends to decrease as the pressure difference between the pressurizing chamber 11 and the auxiliary chamber 7a (low-pressurizing chamber) increases. Therefore, in this embodiment, a configuration is adopted in which one annular groove 2c is provided in the outer cylindrical portion of the plunger 2 to reduce the pressure difference.

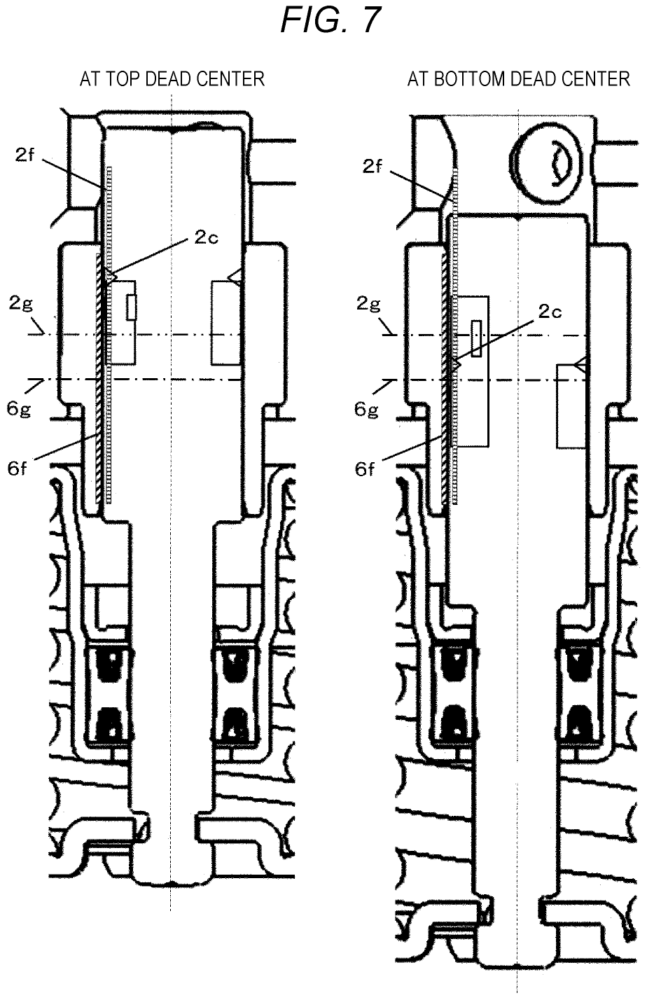

Hereinafter, an effective groove position when the number of the annular grooves 2c is one will be described with reference to FIG. 7. FIG. 7 illustrates a state where the position of the plunger 2 is at the top dead center and at the bottom dead center. The sliding portion (cylinder sliding region) of the cylinder 6 is indicated by a hatched portion 6f, and the center position of the sliding portion 6f of the cylinder 6 is indicated by 6g. At the top dead center position of the plunger 2 illustrated in the left diagram of FIG. 7, the sliding range of the plunger 2 is indicated by a hatched portion 2f, and the center position of the sliding range 2f of the plunger 2 is indicated by 2g.

As described above, in this embodiment, in the fuel supply pump including the plunger 2 reciprocating at the inner peripheral portion of the cylinder 6 and the pressurizing chamber 11 pressurized by the plunger 2, the annular groove 2c is formed at the outer peripheral portion of the plunger 2. It is desirable that the annular groove 2c be configured to be located closer to the pressurizing chamber 11 than the axial center position 6g of the cylinder sliding region 6f at the bottom dead center position of the plunger 2 illustrated in the right diagram of FIG. 7. It is desirable that the annular groove 2c be configured to be located between the axial center position 2g of the plunger sliding region 2f and the axial center position 6g of the cylinder sliding region 6f at the bottom dead center position.

It is desirable that the annular groove 2c be configured to be located closer to the pressurizing chamber 11 than the axial center position 6g of the cylinder sliding region 6f at the top dead center position illustrated in the left diagram of FIG. 7. Further, as a result of the inventors have extensively studied, it is found that, when the annular groove 2c is at the bottom dead center position, the position is desirably located on the side opposite to the pressurizing chamber from the axial center position 2g of the plunger sliding region 2f, and on the pressurizing chamber 11 side from the axial center position 6g of the cylinder sliding region 6f.

That is, with the forming of the annular groove 2c at this position, it is possible to make the upper side of the sliding portion of the plunger 2 (the pressurizing chamber 11 side) higher than the saturated vapor pressure of the fuel (gasoline). The fuel can be suppressed from being evaporated as described above, and as a result, a decrease in lubrication performance can be suppressed.

Further, it is desirable that only one annular groove 2c be formed on the outer peripheral portion of the plunger 2. If a plurality of annular grooves 2c are provided in the plunger 2, it is possible to improve the lubrication performance, but this increases the processing cost. According to this embodiment, it is possible to improve lubrication performance while suppressing an increase in cost.

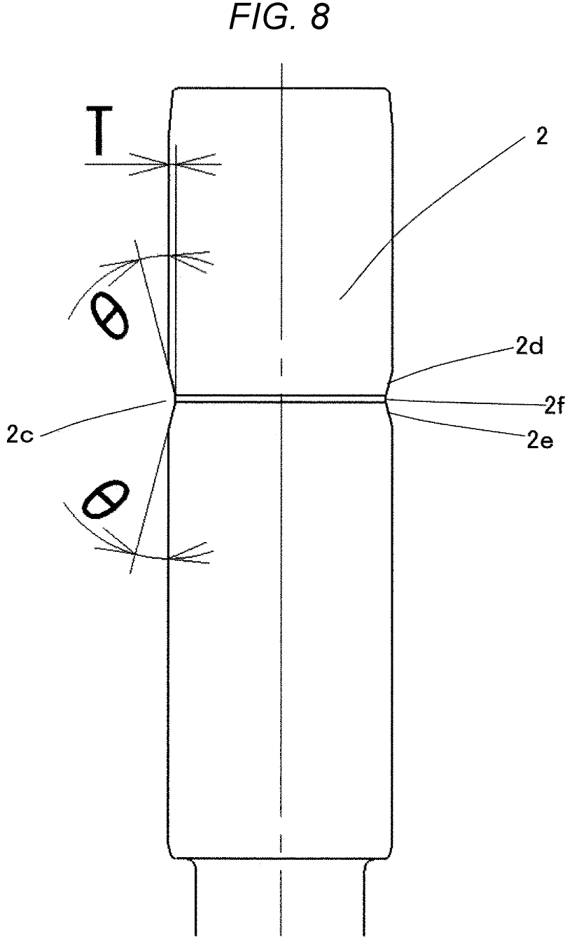

Hereinafter, the shape of the annular groove 2c will be described in detail with reference to FIG. 8. FIG. 8 is an enlarged view of the plunger 2 and illustrates the details of the annular groove 2c. It is desirable that the annular groove 2c have a first tapered surface 2d inclined toward the pressurizing chamber side with respect to the radial direction (left-right direction in FIG. 8) and a second tapered surface 2e inclined toward the anti-pressurizing chamber side with respect to the radial direction. It is preferable that the crossing angle of the first tapered surface with respect to the axial direction (the vertical direction in FIG. 8) of the annular groove 2c be in the range of 10° to 50°. Further, it is desirable that the crossing angle of the second tapered surface 2e with respect to the axial direction of the annular groove 2c (the vertical direction in FIG. 8) be in the range of 10° to 50°. These tapered surfaces are processed by applying a cutting tool. If the crossing angle is larger than 50°, it is necessary to perform the processing with a cutting tool having a small angle. When the angle is small, there is a possibility that the cutting tool may be chipped, and in order to avoid this, it is necessary to use an expensive cutting tool having a very high hardness. With this regard, according to this embodiment, it is possible to secure the required volume of the annular groove 2c at low cost and improve the workability.

The annular groove 2c preferably has a bottom 2f formed in a planar shape between the first tapered surface 2d and the second tapered surface 2e. It is desirable that the annular groove 2c be formed so that the axial length (the length including the first tapered surface 2d, the bottom 2f, and the second tapered surface 2e) is 2 mm or less. Further, it is desirable that the depth T of the annular groove 2c in the radial direction be 1 mm or less. By having a length including the first tapered surface 2d, the bottom 2f, and the second tapered surface 2e in this manner, processing can be easily performed.

### REFERENCE SIGNS LIST

1 pump body
2 plunger
2c annular groove
2d first tapered surface
2e second tapered surface
2f bottom
2f plunger sliding region
2g axial center position
6 cylinder
6f cylinder sliding region
6g axial center position

1. A fuel supply pump, comprising:
a plunger that reciprocates in an inner peripheral portion of a cylinder; and
a pressurizing chamber that is pressurized by the plunger,
wherein an annular groove is formed on an outer periphery of the plunger, and
wherein the annular groove is located closer to the pressurizing chamber than an axial center position of a cylinder sliding region at a bottom dead center position.

2. The fuel supply pump according to claim 1, wherein only one annular groove is formed on an outer peripheral portion of the plunger.

3. The fuel supply pump according to claim 2, wherein the annular groove is located at a bottom dead center position between an axial center position of a plunger sliding region and the axial center position of the cylinder sliding region.

4. The fuel supply pump according to claim 2, wherein the annular groove has a first tapered surface inclined toward a side of the pressurizing chamber with respect to a radial direction and a second tapered surface inclined toward a side opposite to the pressurizing chamber with respect to the radial direction.

5. The fuel supply pump according to claim 4, wherein a crossing angle of the first tapered surface and a crossing angle of the second tapered surface with respect to an axial direction of the annular groove are within a range of 10° to 50°.

6. The fuel supply pump according to claim 4, wherein the annular groove has a bottom formed in a planar shape between the first tapered surface and the second tapered surface.

7. The fuel supply pump according to claim 2, wherein an axial length of the annular groove is 2 mm or less.

8. The fuel supply pump according to claim 2, wherein a radial depth of the annular groove is 1 mm or less.

9. The fuel supply pump according to claim 2, wherein the annular groove is located closer to the pressurizing chamber than the axial center position of the cylinder sliding region at a top dead center position.

10. The fuel supply pump according to claim 2, wherein, at the bottom dead center position, the annular groove is located closer to the side opposite to the pressurizing chamber than the axial center position of the plunger sliding region and closer to the pressurizing chamber than the axial center position of the cylinder sliding region.
